(19) United States
(12) Patent Application Publication
(10) Pub. No.: US 2011/0202906 A1
(43) Pub. Date: Aug. 18, 2011

(54) COMPILING METHOD AND COMPILING PROGRAM

(75) Inventor: Shinobu ASAO, Osaka (JP)

(73) Assignee: PANASONIC CORPORATION, Osaka (JP)

(21) Appl. No.: 13/094,235

(22) Filed: Apr. 26, 2011

Related U.S. Application Data
(63) Continuation of application No. PCT/JP2009/005215, filed on Oct. 7, 2009.

(30) Foreign Application Priority Data
Oct. 30, 2008 (JP) 2008-279822

(51) Int. Cl. G06F 9/45

(52) U.S. Cl. 717/141

(57) ABSTRACT

A compiling method for translating an input program to an object program enables a user to easily ascertain how the input program and the object program are affected by designation of a plurality of extended language specifications. The compiling method includes: analyzing, in the case where the plurality of extended language specifications are designated in the input program, the designated plurality of extended language specifications, to determine which part of the input program is affected by the designated plurality of extended language specifications; and outputting information about the part, together with the object program.

### CROSS REFERENCE TO RELATED APPLICATION(S)

This is a continuation application of PCT application No. PCT/JP2009/005215 filed on Oct. 7, 2009, designating the United States of America.

### BACKGROUND OF THE INVENTION

(1) Field of the Invention

The present invention relates to a compiling method and a compiling program, and particularly relates to a compiling method and a compiling program for translating an input program in which extended language specifications are designated, to an object program.

(2) Description of the Related Art

A compiler of a high-level language (such as C or C++) is typically provided with extended language specifications, in order to achieve optimal performance in a program execution environment.

Here, the program execution environment is an environment in which a program written in the high-level language is executed. Language specifications are specifications of the language, which specify syntax and semantics of the language. Extended language specifications newly (extensibly) specify syntax and semantics of the language, apart from those specified in the language specifications beforehand. In other words, in an extended language specification, a purpose and an operation intended by a description (such as an expression or a statement) are specified. By designating such an extended language specification in the program, it is possible to cause the compiler to operate according to the description (hereafter referred to as an extended language specification statement), such as an expression or a statement, of the designated extended language specification. As a method of designating the extended language specification, for example, a command line option, a pragma (#pragma), or an attribute (_attribute_) is used.

Increases in program size in recent years, however, make it difficult to ascertain how the entire program is affected by designation of extended language specifications. Besides, as the program execution environment is increasingly sophisticated, designable extended language specifications become more detailed and complex, frequently causing a situation where designation of one extended language specification (one extended language specification statement) affects designation of another extended language specification (another extended language specification statement).

Accordingly, in the entire program, the user needs to not only ascertain an operation of a single extended language specification statement, but also ascertain coordination between a plurality of extended language specification statements, for example, how operations are affected when a plurality of relevant extended language specification statements are designated. However, even when the user is highly skilled in the high-level language, it is still difficult to completely ascertain coordination between a plurality of extended language specification statements. Hence, designation of extended language specifications causes unexpected bugs to be embedded.

In view of this, there is a conventional extended language specification designation method whereby candidates of an extended language specification (extended language specification statement) designated by the user are analyzed and an extended language specification (extended language specification statement) for an object is automatically designated based on an analysis result (for example, see Japanese Unexamined Patent Application Publication No. 2007-108940). There is also a method whereby, even when the user does not designate an extended language specification statement, the designation of the extended language specification statement is automatically inserted to modify the input program so that favorable optimization can be achieved (for example, see Japanese Unexamined Patent Application Publication No. 2006-107338). There is further a method whereby designation of an extended language specification statement is checked to prevent the compiler from generating a wrong object program (for example, see Japanese Unexamined Patent Application Publication No. 2006-107339).

### SUMMARY OF THE INVENTION

However, the conventional method has a problem that the user cannot easily ascertain how the input program and the object program are affected by designated extended language specification statements, as shown below. The following describes the problem of the conventional method.

FIG. 25 is a diagram showing an example of state display of designated extended language specification statements in the conventional method. In the conventional method, that is, in the method of Japanese Unexamined Patent Application Publication No. 2007-108940, the user can ascertain for which object a specific (one) extended language specification statement is designated. The user can also ascertain whether the extended language specification statement is designated by an option, by a description in a source program (such as a pragma), or by both of them.

However, in the method of Japanese Unexamined Patent Application Publication No. 2007-108940, though the user can ascertain which part of the input program is affected by the designation of the extended language specification statement, the user cannot ascertain which part of the object program (for example, an assembler program) outputted after compilation is affected by the designation of the extended language specification statement. Besides, though the user can ascertain which extended language specification statement is designated in the input program, the user cannot ascertain how the target object is changed (for example, how its alignment value is changed) by the designated extended language specification statement.

In addition, in the method of Japanese Unexamined Patent Application Publication No. 2007-108940, though it is possible to display for which object a specific (one) extended language specification statement is designated, it is impossible to display by which extended language specification statement an object is affected, as shown in FIG. 25. Therefore, in the case of overlappingly designating a plurality of extended language specification statements for the target object, the user cannot ascertain which of the plurality of extended language specification statements is actually valid.

Moreover, in the method of Japanese Unexamined Patent Application Publication No. 2006-107338, an extended language specification statement is automatically inserted to modify the input program, but there is no consideration of priority and overlapping designation of the inserted extended language specification statement and an already written extended language specification statement for the target object. For example, upon determining an extended language specification statement A as valid, a suggestion that the extended language specification statement A is to be inserted is simply made. However, in the case where an extended language specification statement B whose operation is in coordination with the extended language specification statement A is already written in the program, the operation of the extended language specification statement B is changed as a result of the insertion of the extended language specification statement A. Thus, the lack of consideration of priority and overlapping designation leads to a problem that the program does not operate as originally intended by the user.

Likewise, in the method of Japanese Unexamined Patent Application Publication No. 2006-107339, the effect of designation overlap with the already written extended language specification statement is not taken into consideration. For instance, there is a problem that, in the case of a program which operates as expected through coordination of the extended language specification statement A and the extended language specification statement B, due to the lack of consideration of the effect of overlapping designation, only the extended language specification statement A is checked, resulting in determination as an error.

The present invention has been made in view of the above problems, and has an object of providing a compiling method and a compiling program that enable the user to easily ascertain how an input program and an object program are affected by designation of a plurality of extended language specifications.

A compiling method according to the present invention is a compiling method for translating an input program to an object program, the compiling method including: analyzing, in the case where a plurality of extended language specifications are designated in the input program, the designated plurality of extended language specifications, to determine which part of the input program is affected by the designated plurality of extended language specifications; and outputting information about the part, together with the object program.

According to this method, the user can easily ascertain how the input program and the object program are affected by the designated plurality of extended language specifications (extended language specification statements).

Preferably, the analyzing includes determining, based on priority specified for the plurality of extended language specifications, designation of a valid extended language specification from among the plurality of extended language specifications, and determining the part of the input program affected by the designation of the valid extended language specification, and the outputting includes outputting the information about the part, together with the object program, the information about the part indicating at least one of: the designation of the valid extended language specification; an object in the input program affected by the designation of the valid extended language specification; the specified priority; and a change of the object as a result of being affected by the designation of the valid extended language specification.

Preferably, the outputting includes including the information about the part in the input program, and outputting the input program including the information about the part, together with the object program.

According to this method, the user can easily ascertain how the input program is affected by the plurality of extended language specifications (extended language specification statements) designated by the user. This contributes to improved inspection efficiency.

Preferably, the outputting includes including the information about the part in the object program, and outputting the object program including the information about the part.

According to this method, the user can easily ascertain how the object program is affected by the plurality of extended language specifications (extended language specification statements) designated by the user. This contributes to improved inspection efficiency.

Preferably, the outputting further includes checking, based on the information about the part, whether or not alignment of an object in the input program is changed and, in the case where the changed alignment of the object does not match expected alignment, outputting a warning indicating that the object is misaligned.

According to this method, unexpected inter-object misalignment that may occur by the user designating the extended language specifications (extended language specification statements) can be detected in compilation. This contributes to improved inspection efficiency.

Preferably, the outputting further includes: checking, for each object in the input program including an object affected by the designation of the plurality of extended language specifications, whether or not alignment of the object is changed to optimal alignment for a transfer instruction in a program execution environment, based on the information about the part; and in the case where alignment of at least one object in the input program is not changed to the optimal alignment, outputting a suggestion for the optimal alignment of the at least one object.

According to this method, even a programmer not familiar with information relating to the program execution environment can efficiently designate an extended language specification (extended language specification statement) for alignment that enhances code generation efficiency. This contributes to improved tuning efficiency.

Preferably, the priority of the plurality of extended language specifications is pre-specified.

Preferably, the priority of the plurality of extended language specifications is further specified by a user, and the analyzing uses the priority specified by the user, as the priority specified for the plurality of extended language specifications.

According to this method, apart from priority pre-specified for the extended language specifications (extended language specification statements), the user can separately designate priority. This contributes to improved inspection efficiency.

Note that the present invention can be realized not only as a compiling method including such characteristic steps, but also as a compiling apparatus including processing units corresponding to the characteristic steps included in the compiling method or a compiler causing a computer to execute the characteristic steps included in the compiling method. Such a compiler can be distributed via a recording medium such as a CD-ROM (Compact Disc-Read Only Memory) or a transmission medium such as the Internet.

According to the present invention, a compiling method and a compiling program that enable the user to easily ascertain how an input program and an object program are affected by designation of a plurality of extended language specifications (extended language specification statements) can be realized. As a result, the number of inspection steps can be reduced.

Moreover, unexpected misalignment that may occur by the user designating the extended language specification statements in the input program can be accurately detected in compilation, in consideration of priority among the extended language specification statements. Furthermore, an extended language specification statement for alignment that enhances code generation efficiency can be suggested by a compiler. As a result, not only the number of inspection steps can be reduced, but also the number of program tuning steps by the user can be reduced.

Further Information about Technical Background to this Application

The disclosure of Japanese Patent Application No. 2008-279822 filed on Oct. 30, 2008 including specification, drawings and claims is incorporated herein by reference in its entirety.

The disclosure of PCT application No. PCT/JP2009/005215 filed on Oct. 7, 2009, including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a diagram showing characteristic processing steps of a compiling method in an embodiment of the present invention;

FIG. 2 is a flowchart showing processing executed by a compiler in the embodiment of the present invention;

FIG. 3 is a flowchart showing processing in an extended language specification analysis step in the embodiment of the present invention;

FIG. 4 is a flowchart showing processing in an extended language specification information output step in the embodiment of the present invention;

FIG. 5 is a flowchart showing processing in an extended language specification information-added input program output step in the embodiment of the present invention;

FIG. 6 is a flowchart showing processing in an extended language specification information-added object program output step in the embodiment of the present invention;

FIG. 7 is a flowchart showing processing in an inter-object warning output step in the embodiment of the present invention;

FIG. 8 is a flowchart showing processing in an optimization suggestion output step in the embodiment of the present invention;

FIG. 9A is a diagram showing an input program and compiling preconditions in Example 1 of the present invention;

FIG. 9B is a diagram showing the input program and the compiling preconditions in Example 1 of the present invention;

FIG. 9C is a diagram showing the input program and the compiling preconditions in Example 1 of the present invention;

FIG. 9D is a diagram showing the input program and the compiling preconditions in Example 1 of the present invention;

FIG. 9E is a diagram showing the input program and the compiling preconditions in Example 1 of the present invention;

FIG. 10 is a table showing an analysis result registered in an extended language specification information database for the input program in Example 1 of the present invention;

FIG. 11 is a diagram showing the input program to which extended language specification information is added in Example 1 of the present invention;

FIG. 12A is a diagram showing an input program and compiling preconditions in Example 2 of the present invention;

FIG. 12B is a diagram showing the input program and the compiling preconditions in Example 2 of the present invention;

FIG. 12C is a diagram showing the input program and the compiling preconditions in Example 2 of the present invention;

FIG. 12D is a diagram showing the input program and the compiling preconditions in Example 2 of the present invention;

FIG. 12E is a diagram showing the input program and the compiling preconditions in Example 2 of the present invention;

FIG. 13 is a table showing an analysis result registered in the extended language specification information database for the input program in Example 2 of the present invention;

FIG. 14 is a diagram showing the input program to which extended language specification information is added in Example 2 of the present invention;

FIG. 15 is a diagram showing an object program before extended language specification information is added in Example 3 of the present invention;

FIG. 16 is a diagram showing the object program to which the extended language specification information is added in Example 3 of the present invention;

FIG. 17 is a diagram showing an input program in Example 4 of the present invention;

FIG. 18 is a diagram showing extended language specification information registered in the extended language specification information database for the input program in Example 4 of the present invention;

FIG. 19 is a diagram showing the input program to which a misalignment warning is added in Example 4 of the present invention;

FIG. 20A is a diagram showing an input program and optimal alignment for a transfer instruction in a program execution environment in Example 5 of the present invention;

FIG. 20B is a diagram showing the input program and the optimal alignment for the transfer instruction in the program execution environment in Example 5 of the present invention;

FIG. 21 is a diagram showing extended language specification information registered in the extended language specification information database for the input program in Example 5 of the present invention;

FIG. 22 is a table showing each object in the input program and its object size, optimal alignment, and current alignment in Example 5 of the present invention;

FIG. 23 is a diagram showing the input program to which an optimization suggestion is added in Example 5 of the present invention;

FIG. 24 is a diagram showing a structure of a compiling apparatus including processing units corresponding to the characteristic steps included in the compiling method according to the present invention; and

FIG. 25 is a diagram showing an example of state display of extended language specification statements in a conventional method.

### DESCRIPTION OF THE PREFERRED EMBODIMENT(S)

The following describes an embodiment of the present invention with reference to drawings.

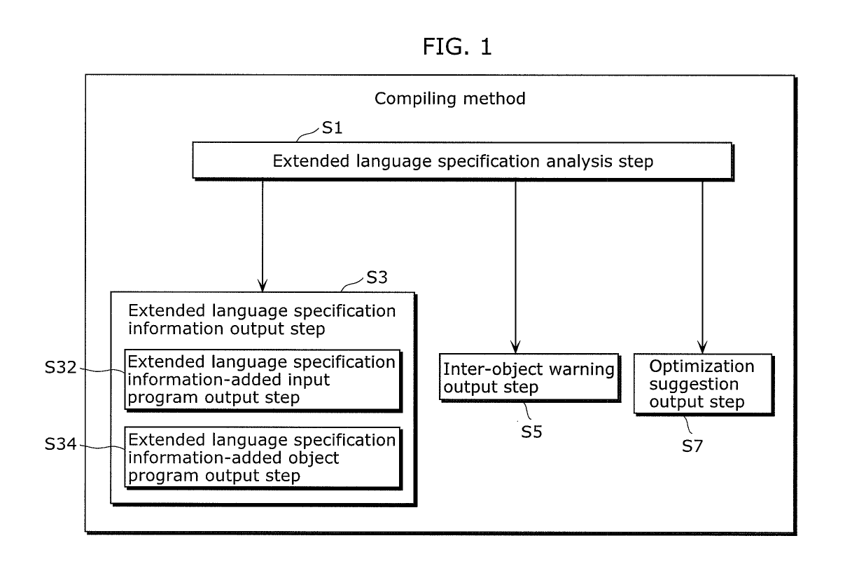

FIG. 1 is a diagram showing characteristic processing steps of a compiling method in the embodiment of the present invention.

As shown in FIG. 1, the compiling method according to the present invention includes an extended language specification analysis step (S1) of analyzing information (hereafter referred to as extended language specification information) about which part of an input program is affected by a plurality of extended language specification statements added in the input program by the user, based on priority of the plurality of extended language specification statements. The compiling method according to the present invention also includes an extended language specification information output step (S3) of outputting the extended language specification information analyzed in the extended language specification analysis step (S1) as a compiling result, to display it to the user. The compiling method according to the present invention further includes an inter-object warning output step (S5) of detecting inter-object misalignment based on the analyzed extended language specification information and outputting a warning indicating that misalignment occurs as a result of compilation, and an optimization suggestion output step (S7) of outputting, based on the analyzed extended language specification information, a suggestion for an extended language specification statement designation method that enhances code performance, to the user.

The extended language specification information output step (S3) includes an extended language specification information-added input program output step (S32) of outputting the input program to which the extended language specification information is added, and an extended language specification information-added object program output step (S34) of outputting an object program to which the extended language specification information is added.

In the compiling method according to the present invention, the extended language specification information output step (S3), the inter-object warning output step (S5), and the optimization suggestion output step (S7) can each be independently performed after the extended language specification analysis step (S1). For each of steps S3, S5, and S7, whether or not to perform the step can be selected according to the user's designation (such as an option).

The user's designation mentioned here is an extended language specification statement added in the input program. The user designates an extended language specification (extended language specification statement) by, for example, a command line option, a pragma (#pragma), or an attribute (_attribute_).

The following describes the compiling method in the embodiment of the present invention, with reference to drawings.

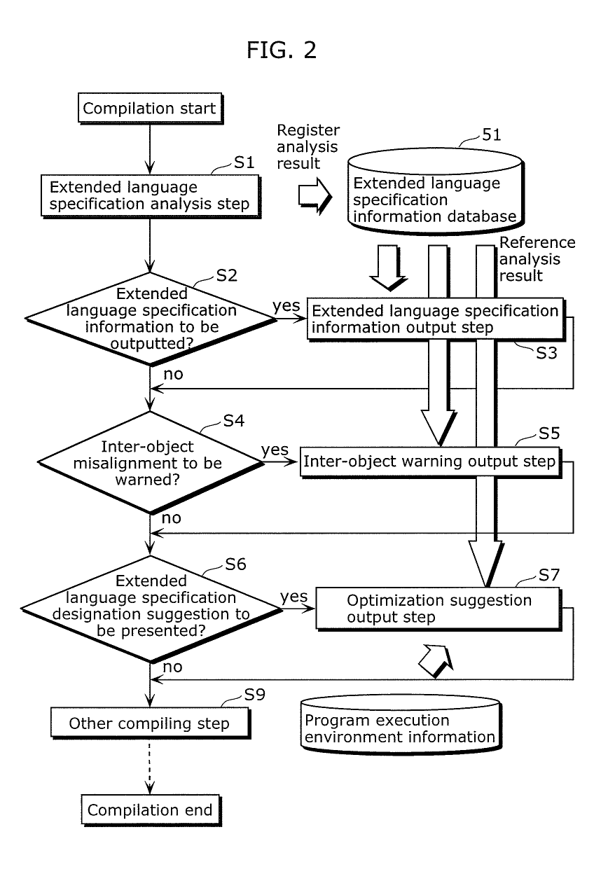

FIG. 2 is a flowchart showing processing executed by a compiler in the embodiment of the present invention.

Here, the compiler is software (compiling program) for translating a software design (input program) written in a programming language by a person, to a form (object code) executable by a computer. The compiler is executed on a computer including a memory and a CPU, and translates the input program to an assembly language which is intermediate code and then to an object program.

The following description is based on an assumption that the compiler is a program for implementing the compiling method according to the present invention.

First, the compiler executes an input step of reading the input program.

Next, the compiler executes, for the input program read in the input step, the extended language specification analysis step of analyzing information about which part of the input program is affected by a plurality of extended language specification statements added in the input program by the user, based on an extended language specification designation status, i.e., priority of the plurality of extended language specification statements. The compiler registers an analysis result in an extended language specification information database 51, as extended language specification information (S1).

Examples of the extended language specification information include: an extended language specification statement (hereafter referred to as a valid extended language specification statement) that is valid among the plurality of extended language specification statements; an object affected by the extended language specification statement; priority of the plurality of extended language specification statements adopted in compilation (hereafter referred to as adopted priority); and a change of the object (hereafter referred to as an object change) as a result of being affected by the extended language specification statement.

The extended language specification information database 51 is a database in which extended language specification information is stored. Note that the extended language specification information database 51 may be provided as an external storage unit or an internal storage unit for the compiler.

Next, the compiler determines whether or not to output the extended language specification information, according to the user's designation (such as an option) (S2). In the case of outputting the extended language specification information (S2: yes), the compiler executes the extended language specification information output step of outputting the extended language specification information analyzed in the extended language specification analysis step (S1) to display it to the user, with reference to the extended language specification information database 51 (S3). After the extended language specification information output step (S3), the compiler executes step S4. Note that, in the case where the compiler determines not to output the extended language specification information in step S2 (S2: no), too, the compiler executes step S4.

The compiler determines whether or not to warn of inter-object misalignment, according to the user's designation (such as an option) (S4).

In the case of warning of inter-object misalignment (S4: yes), the compiler executes the inter-object warning output step of detecting inter-object misalignment in compilation and outputting a warning indicating that misalignment occurs as a result of compilation, with reference to the extended language specification information database 51 (S5). After the inter-object warning output step (S5), the compiler goes to step S6.

Note that, in the case where the compiler determines not to warn of inter-object misalignment (S4: no), too, the compiler executes step S6.

The compiler determines whether or not to present an extended language specification designation suggestion, according to the user's designation (such as an option) (S6).

In the case of presenting an extended language specification designation suggestion (S6: yes), the compiler executes the optimization suggestion output step of outputting, to the user, a suggestion for an extended language specification designation method that enhances code performance, with reference to the extended language specification information database 51 and program execution environment information (S7). The program execution environment information mentioned here is information set beforehand for an optimization suggestion, and includes, for example, optimal alignment information set beforehand.

After this, the compiler executes other compiling step (S9), and outputs a compiling result together with the object program.

Note that, in the case where the compiler determines not to present the extended language specification designation suggestion (S6: no), too, the compiler executes step S9.

The other compiling step (S9) is a compiling step not relevant to the present invention and is not a main feature of the present invention, and so its description is omitted.

The extended language specification analysis step (S1), the extended language specification information output step (S3), the inter-object warning output step (S5), and the optimization suggestion output step (S7) are not necessarily performed immediately after the start of the compilation, and may be performed after the other compiling step such as parsing or semantic analysis.

The following describes each of the extended language specification analysis step (S1), the extended language specification information output step (S3), the inter-object warning output step (S5), and the optimization suggestion output step (S7) which are main features of the present invention.

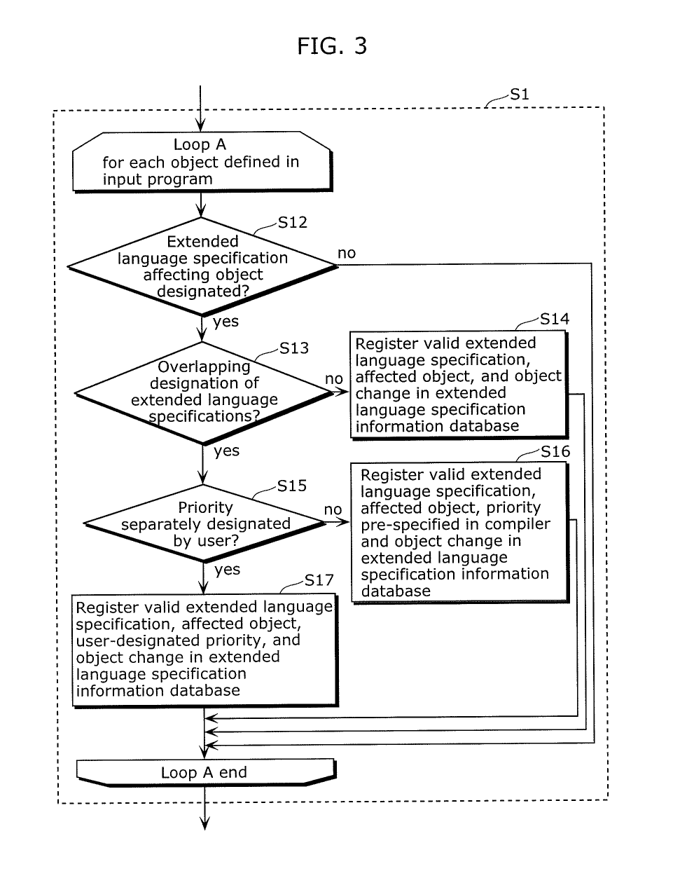

FIG. 3 is a flowchart showing processing in the extended language specification analysis step in the embodiment of the present invention.

In the extended language specification analysis step (S1), the compiler performs the following processing (hereafter referred to as a loop A) for each object defined in the input program.

First, the compiler determines whether or not an extended language specification affecting the object is designated in the input program (S12). In the case where the extended language specification is not designated (S12: no), the compiler performs the loop A on the next object.

In the case where the extended language specification statement affecting the object is designated in the input program (S12: yes), the compiler determines whether or not there is overlapping designation of extended language specification statements for the object in the input program (S13). In the case where there is no overlapping designation of extended language specification statements (S13: no), the compiler registers the valid extended language specification statement, the object affected by the extended language specification statement, and the object change in the extended language specification information database 51 as extended language specification information (S14). The compiler then performs the loop A on the next object.

In the case where there is overlapping designation of extended language specification statements (S13: yes), the compiler determines whether or not priority of the extended language specification statements is separately designated by the user (S15). In the case where the priority of the extended language specification statements is not separately designated by the user (S15: no), the compiler registers the valid extended language specification statement, the object affected by the extended language specification statement, priority pre-specified in the compiler as the adopted priority, and the object change in the extended language specification information database 51 as extended language specification information (S16). The compiler then performs the loop A on the next object.

In the case where the priority of the extended language specification statements is separately designated by the user (S15: yes), the compiler registers the valid extended language specification statement, the object affected by the extended language specification statement, user-designated priority as the adopted priority, and the object change in the extended language specification information database 51 as extended language specification information (S17). The compiler then performs the loop A on the next object.

In the above manner, the compiler executes the extended language specification analysis step (S1).

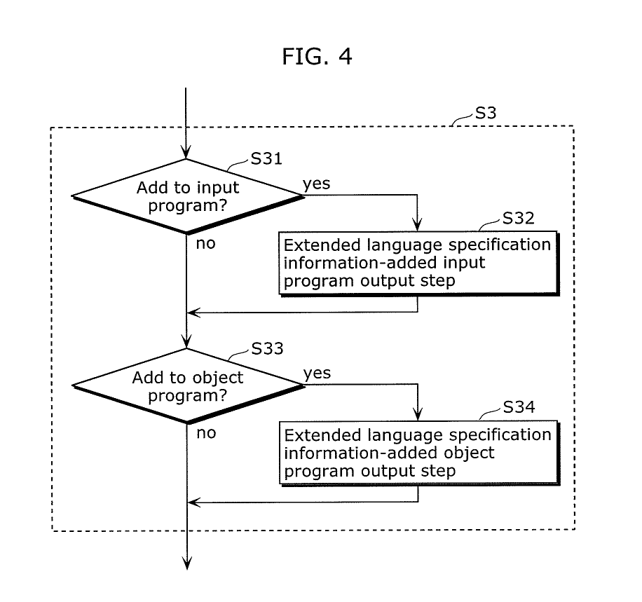

FIG. 4 is a flowchart showing processing in the extended language specification information output step in the embodiment of the present invention.

In the extended language specification information output step (S3), the compiler first determines whether or not to add the extended language specification information to the input program (S31). In the case of adding the extended language specification information to the input program (S31: yes), the compiler executes the extended language specification information-added input program output step (S32). After the extended language specification information-added input program output step (S32), the compiler executes step S33.

Note that, in the case where the compiler determines not to add the extended language specification information to the input program in step S31 (S31: no), too, the compiler executes next step S33.

The compiler determines whether or not to add the extended language specification information to the object program (S33). In the case of adding the extended language specification information to the object program (S33: yes), the compiler executes the extended language specification information-added object program output step (S34). After the extended language specification information-added object program output step (S34), the compiler executes next step S4. Note that, in the case where the compiler determines not to add the extended language specification information to the object program in step S33 (S33: no), too, the compiler executes next step S4.

In the above manner, the compiler executes the extended language specification information output step (S3).

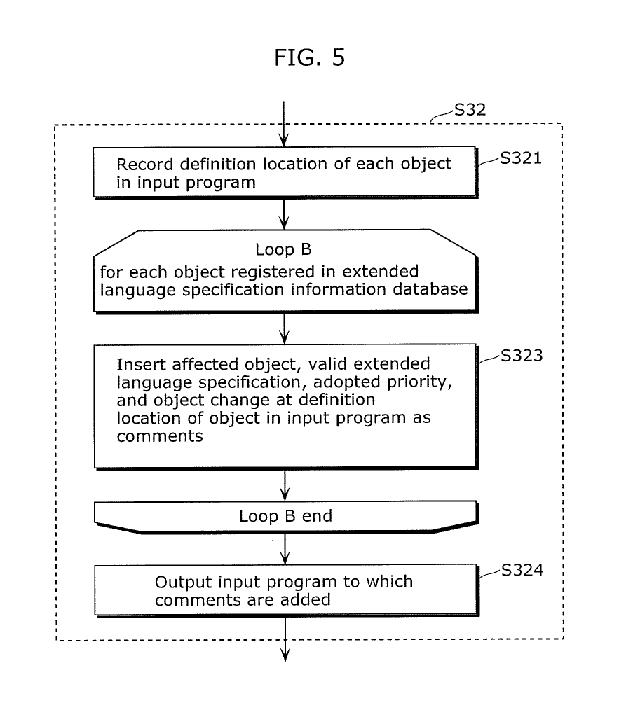

FIG. 5 is a flowchart showing processing in the extended language specification information-added input program output step in the embodiment of the present invention.

In the extended language specification information-added input program output step (S32), the compiler first records a definition location of each object in the input program (S321). The compiler then performs the following processing (hereafter referred to as a loop B) on each object registered in the extended language specification information database 51. Here, the definition location of each object in the input program may be recorded in the extended language specification information database 51, or recorded in a temporary storage unit provided for the compiler.

In the loop B, the compiler inserts, as comments, the extended language specification information including the object affected by the extended language specification statement, the valid extended language specification statement, the adopted priority, and the object change, in the input program at the object definition location recorded in step S321 (S323).

After executing the loop B for each object registered in the extended language specification information database 51, the compiler outputs the input program to which the comments are added (S324). The compiler then executes next step S33.

In the above manner, the compiler executes the extended language specification information-added input program output step (S32).

Though the compiler outputs the compiling result by adding the extended language specification information in the input program as comments, the present invention is not limited to this. For instance, the extended language specification information may be outputted as a separate file such as a text file.

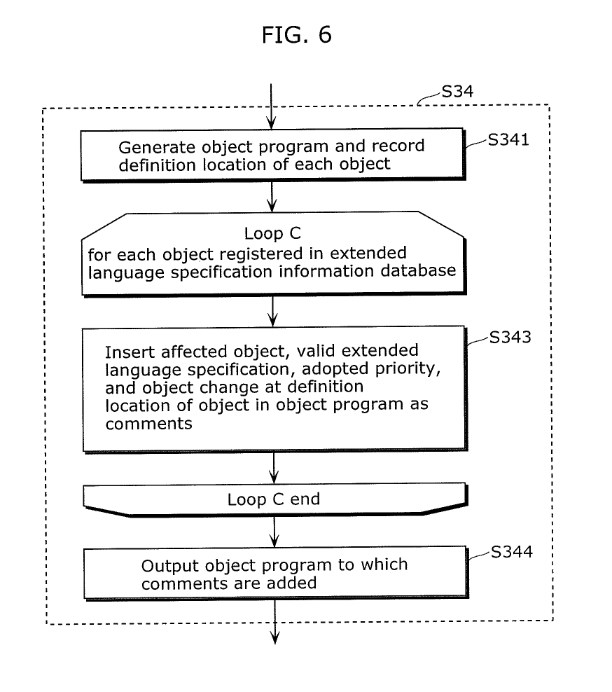

FIG. 6 is a flowchart showing processing in the extended language specification information-added object program output step in the embodiment of the present invention.

In the extended language specification information-added object program output step (S34), the compiler first generates the object program beforehand, and records a definition location of each object (S341). The compiler then performs the following processing (hereafter referred to as a loop C) on each object registered in the extended language specification information database 51. Here, the object program generated beforehand and the definition location of each object may be recorded in the extended language specification information database 51, or recorded in a temporary storage unit provided for the compiler.

In the loop C, the compiler inserts, as comments, the extended language specification information including the object affected by the extended language specification statement, the valid extended language specification statement, the adopted priority, and the object change, in the object program at the object definition location recorded in step S341 (S343).

After executing the loop C for each object registered in the extended language specification information database 51, the compiler outputs the object program to which the comments are added (344). The compiler then executes next step S4.

In the above manner, the compiler executes the extended language specification information-added object program output step (S34).

Though the compiler outputs the compiling result by adding the extended language specification information in the object program as comments, the present invention is not limited to this. For instance, the extended language specification information may be outputted as a separate file such as a text file.

Moreover, the extended language specification information may include information other than the object affected by the extended language specification statement, the valid extended language specification statement, the adopted priority, and the object change. For example, an assembler instruction in a compiling process affected by the designated extended language specification statement and an assembler instruction in a compiling process in the case where the designation of the extended language specification statement is nullified may be included in the extended language specification information.

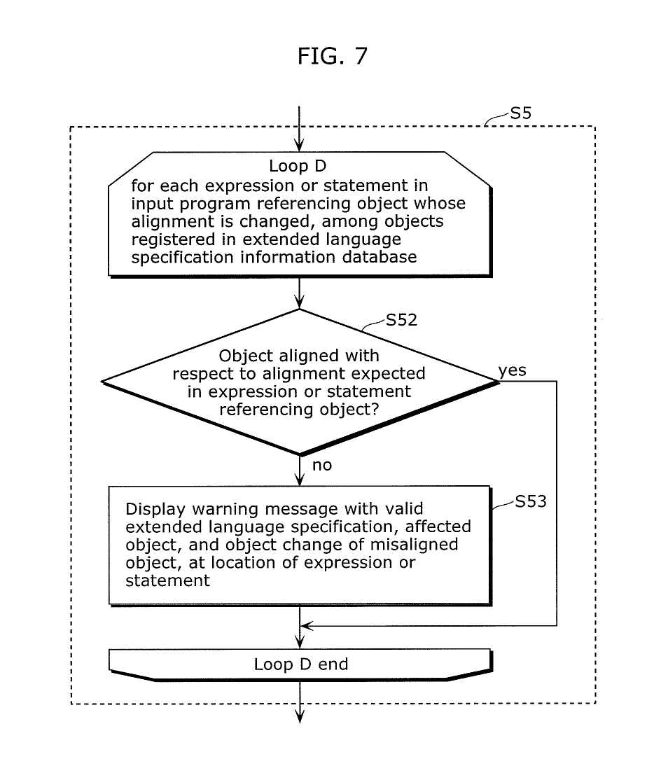

FIG. 7 is a flowchart showing processing in the inter-object warning output step in the embodiment of the present invention.

In the inter-object warning output step (S5), the compiler performs the following processing (hereafter referred to as a loop D) on each expression or statement in the input program referencing an object whose alignment is changed, among objects registered in the extended language specification information database 51.

In the loop D, the compiler first checks whether or not there is no misalignment of the object whose alignment is changed, with respect to alignment expected in the expression or statement referencing the object (i.e., whether or not the changed alignment of the object matches the expected alignment) (S52). In the case where there is no misalignment (S52: yes), the compiler performs the loop D on the next expression or statement in the input program.

In the case where there is misalignment (S52: no), the compiler outputs a warning message with the extended language specification information including the valid extended language specification statement, the object affected by the extended language specification statement, and the object change of the misaligned object at the location of the expression or statement, to display it to the user (S53). The compiler then performs the loop D on the next expression or statement.

In the above manner, the compiler executes the inter-object warning output step (S5).

Though the compiler outputs the warning message to display it in the above example, the present invention is not limited to this. For example, the input program including the warning message may be outputted, or the warning message may be outputted as a separate file such as a text file.

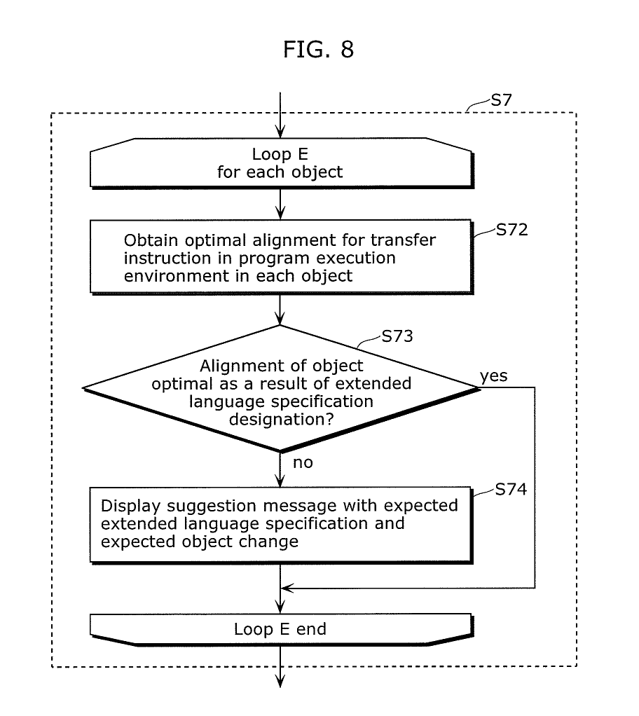

FIG. 8 is a flowchart showing processing in the optimization suggestion output step in the embodiment of the present invention.

In the optimization suggestion output step (S7), the compiler performs the following processing (hereafter referred to as a loop E) on each object in the input program.

In the loop E, the compiler first obtains optimal alignment for a transfer instruction in a program execution environment, in each object (S72). Note that such optimal alignment information may be registered in the compiler beforehand, or may be separately inputted by the user. The program execution environment denotes a program that serves as a basis for executing a program written in a high-level language.

Next, the compiler determines whether or not the alignment of the object is the optimal alignment (S73). Though step S73 is described as the determination of whether or not the alignment of the object changed as a result of extended language specification designation is the optimal alignment, the present invention is not limited to the result of extended language specification designation.

In the case where the compiler determines that the alignment is the optimal alignment (S73: yes), the compiler performs the loop E on the next object.

On the other hand, in the case where the compiler determines that the alignment is not the optimal alignment (S73: no), the compiler outputs a suggestion message with an expected extended language specification statement and an expected object change, to display it to the user (S74). The compiler then performs the loop E on the next object.

In the above manner, the compiler executes the optimization suggestion output step (S7).

Though the compiler outputs the suggestion message to display it in the above example, the present invention is not limited to this. For example, the input program including the suggestion message may be outputted, or the suggestion message may be outputted as a separate file such as a text file.

As described above, the compiler performs the extended language specification analysis step (S1), the extended language specification information output step (S3), the inter-object warning output step (S5), and the optimization suggestion output step (S7). Hence, a compiling method and a compiling program that enable the user to easily ascertain how the input program and the object program are affected by designation of a plurality of extended language specification statements can be realized.

That is, in the compiling method according to the present invention, the user can easily ascertain how the input program and the object program are affected by designation of extended language specifications by the user, while such ascertainment has not been possible in the conventional art. As a result, the number of inspection steps by the user can be reduced. Moreover, in the compiling method according to the present invention, unexpected misalignment that may occur by designation of extended language specifications can be detected in compilation. As a result, the number of inspection steps can be reduced. Furthermore, an extended language specification for alignment designation that enhances code generation efficiency can be suggested by the compiler. As a result, the number of program tuning steps by the user can be reduced.

The following describes Examples of the compiling method according to the present invention in detail, using specific examples of input programs.

### Example 1

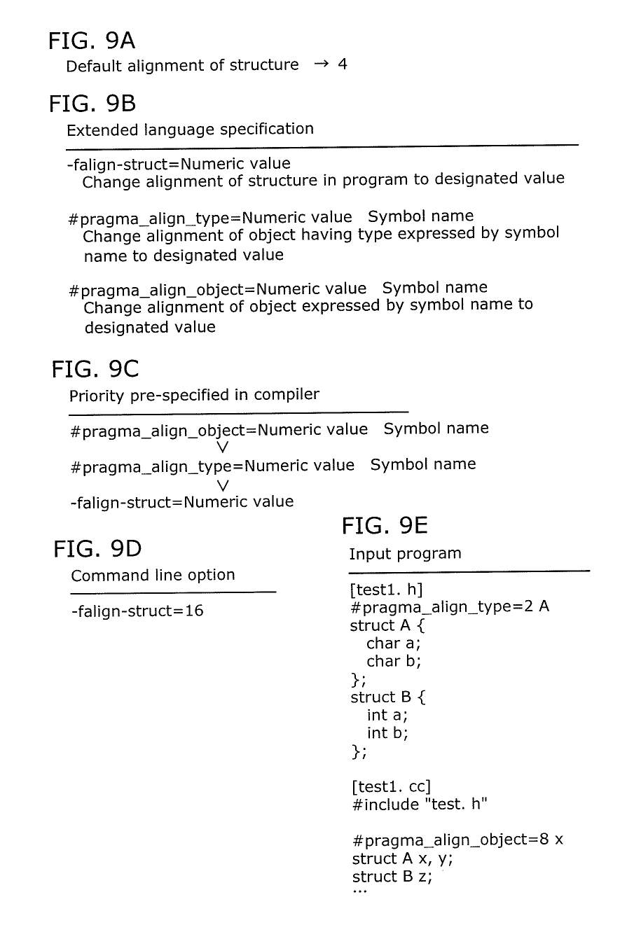

FIGS. 9A to 9E are diagrams showing an input program and compiling preconditions in Example 1 of the present invention. FIGS. 9A to 9D show the compiling preconditions, and FIG. 9E shows the input program. As shown in FIG. 9E, the input program is made up of test1.h and test1.cc. Meanwhile, extended language specification statements designated by the user, priority pre-specified in the compiler, and a command line option designated in compilation are shown in FIGS. 9A to 9D as compiling preconditions.

As other preconditions, the user designates that extended language specification information is to be added to the input program and not the object program, inter-object misalignment is not to be warned, and an extended language specification designation suggestion is not to be presented. Moreover, there is no designation of priority of extended language specification statements by the user.

Upon starting compilation, the compiler first executes the substeps of the extended language specification analysis step (S1) in sequence. That is, the compiler executes the loop A in the extended language specification analysis step (S1) shown in FIG. 3. The loop A is performed on each of objects x, y, and z in test1.cc in the input program shown in FIG. 9E.

As shown in FIGS. 9D and 9E, three extended language specification statements in the extended language specifications are overlappingly designated for object x. In detail, a first extended language specification statement is a command line option “-falign-struct=16” shown in the preconditions in FIG. 9D, which is designation for all structure objects in the program. A second extended language specification statement is a pragma “#pragma_align_type=2A” designated in the input program in FIG. 9E (because object x has type A). A third extended language specification statement is a pragma “#pragma_align_object=8x” designated in the input program in FIG. 9E (because it is designated for object x).

Accordingly, the determination of step S12 by the compiler results in yes, and also the determination of step S13 which follows results in yes. The compiler then goes to step S15. Since the user does not designate priority of extended language specification statements according to the above preconditions, the determination of step S15 by the compiler results in no, and the compiler goes to step S16.

In step S16, “#pragma_align_object=8x” which is highest in priority is selected as the valid extended language specification statement among the overlappingly designated extended language specification statements, according to priority pre-specified (defined) in the compiler as shown in FIG. 9C.

Therefore, in step S16, the valid extended language specification statement, the affected object, the priority pre-specified in the compiler, and the object change are registered in the extended language specification information database 51, as extended language specification information.

Moreover, as shown in FIGS. 9D and 9E, two extended language specification statements are overlappingly designated for object y. In detail, a first extended language specification statement is the command line option “-falign-struct=16” shown in FIG. 9D. A second extended language specification statement is the pragma “#pragma_align_type=2A” designated in the input program in FIG. 9E (because object y has type A).

Accordingly, the determination of step S12 by the compiler results in yes, and also the determination of step S13 which follows results in yes. The compiler then goes to step S15. The determination of step S15 by the compiler results in no according to the above preconditions, and the compiler goes to step S16.

In step S16, “#pragma_align_type=2A” which is highest in priority is selected as the valid extended language specification statement among the overlappingly designated extended language specification statements, according to the priority pre-specified in the compiler as shown in FIG. 9C. Therefore, in step S16, the same extended language specification information as object x is registered in the extended language specification information database 51.

On the other hand, only one extended language specification statement, i.e., the command line option “-falign-struct=16” shown in FIG. 9D, is designated for object z. Accordingly, the determination of step S12 by the compiler results in yes, and the determination of step S13 which follows results in no. The compiler then executes step S14. As a result, the valid extended language specification statement, the affected object, and the object change are registered in the extended language specification information database 51 as extended language specification information.

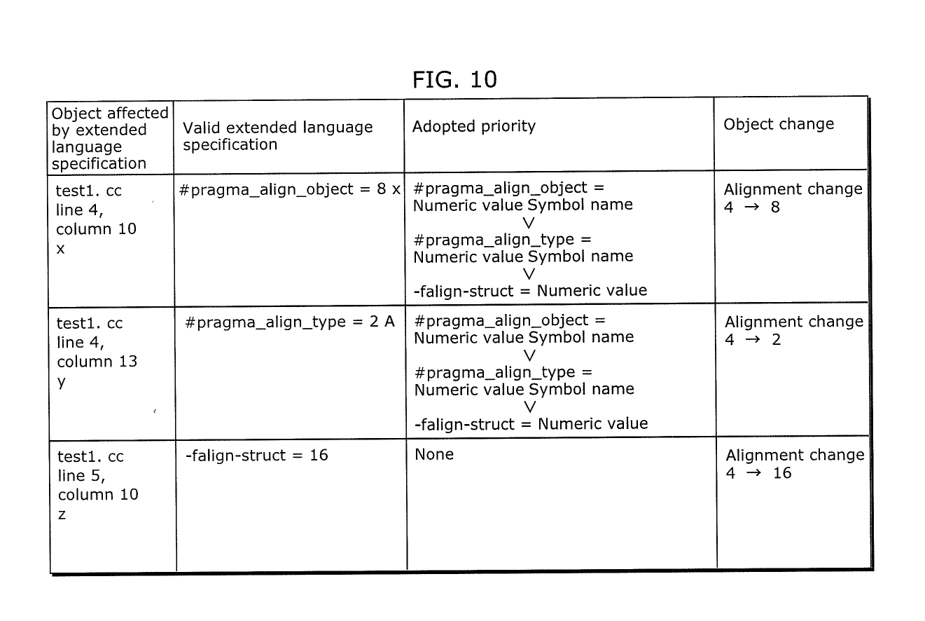

FIG. 10 is a table showing an analysis result registered in the extended language specification information database 51, for the input program in Example 1 of the present invention. FIG. 10 is a table showing the extended language specification information registered as a result of the analysis in the extended language specification analysis step (S1), that is, a table showing the result of registering the extended language specification information for objects x, y, and z described above.

Next, the compiler performs the determination of step S2. Since the compiler is designated to add the extended language specification information to the input program according to the above preconditions, the determination of step S2 results in yes, and so the compiler executes the extended language specification information output step (S3). In the extended language specification information output step (S3), the determination of step S31 results in yes, and so the compiler executes the extended language specification information-added input program output step (S32).

Hence, the compiler executes the substeps of step S32 shown in FIG. 5.

In step S32, the compiler first executes step S321, to record a definition location of each object in the input program as temporary data. In Example 1, object x is defined in line 4, column 10 in test1.cc, object y is defined in line 4, column 13 in test1.cc, and object z is defined in line 5, column 10 in test1.cc.

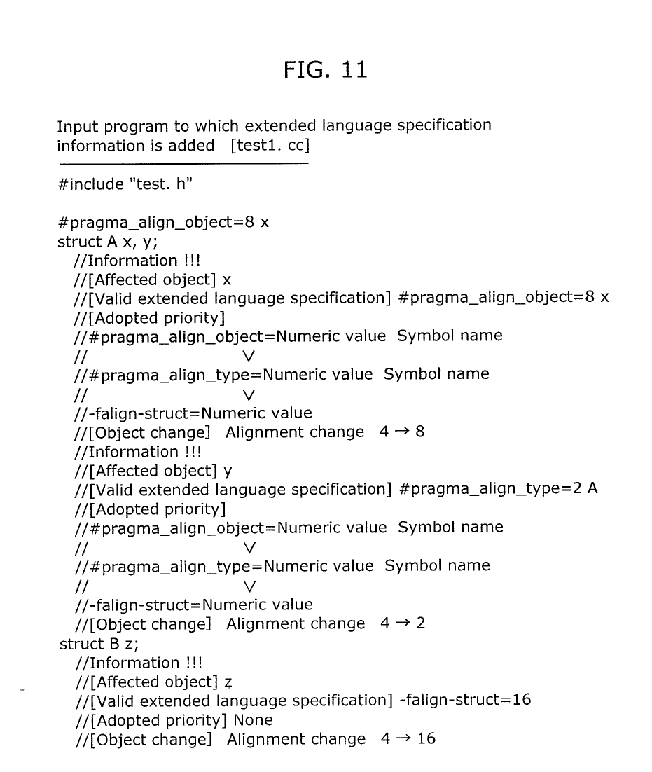

Following this, the compiler executes the loop B, where step S323 is performed on each of objects x, y, and z. Since the definition location of the object is recorded in step S321, the affected object, the valid extended language specification statement, the adopted priority, and the object change (which are registered in the extended language specification information database 51) are inserted at the definition location in the input program, as comments. In step S324, the compiler outputs the input program to which the comments are added. FIG. 11 shows an output example of the input program to which the extended language specification information is added.

FIG. 11 is a diagram showing the input program to which the extended language specification information is added in Example 1 of the present invention. As can be seen from FIG. 11, the user can easily ascertain how each object in the input program is affected by the user designating the extended language specification statements, while such ascertainment has not been possible in the conventional art. Moreover, in Example 1, step S9 is performed while omitting steps S34, S5, and S7 before completing compilation, according to the above preconditions.

Thus, as demonstrated in Example 1, by performing the extended language specification analysis step (S1) and the extended language specification information output step (S3) by the compiler, the user can easily ascertain how the input program is affected by the extended language specifications designated by the user. As a result, the number of inspection steps can be reduced.

### Example 2

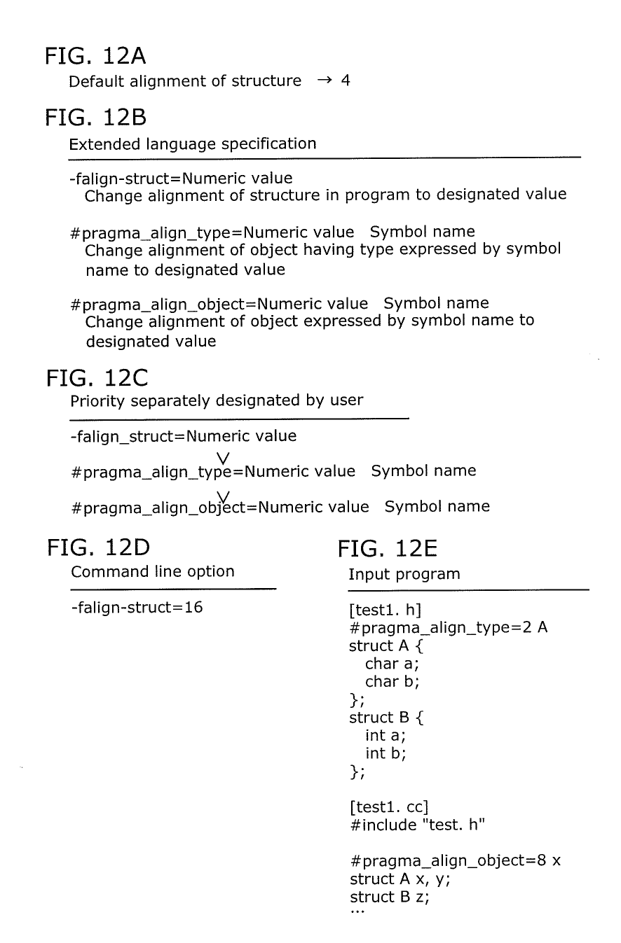

FIGS. 12A to 12E are diagrams showing an input program and compiling preconditions in Example 2 of the present invention. FIGS. 12A to 12D show the compiling preconditions, and FIG. 12E shows the input program. Though the preconditions shown in FIGS. 12A to 12D are similar to those shown in FIGS. 9A to 9D in Example 1, the priority of the extended language specification statements is not the priority pre-specified in the compiler, but priority separately designated by the user. That is, in FIGS. 12A to 12D, the preconditions other than the priority of the extended language specification statements are the same as in Example 1.

In this case, the same processing as in Example 1 is performed, and so its description is omitted. Since the priority is separately designated by the user in Example 2, the determination of step S15 by the compiler results in yes, and the compiler goes to step S17.

In step S17, the command line option “-falign-struct=16” highest in priority as shown in FIG. 12C is selected for the object for which the extended language specification statements are overlappingly designated. Accordingly, in step S17, the valid extended language specification statement, the affected object, the user-designated priority, and the object change are registered in the extended language specification information database 51 as extended language specification information.

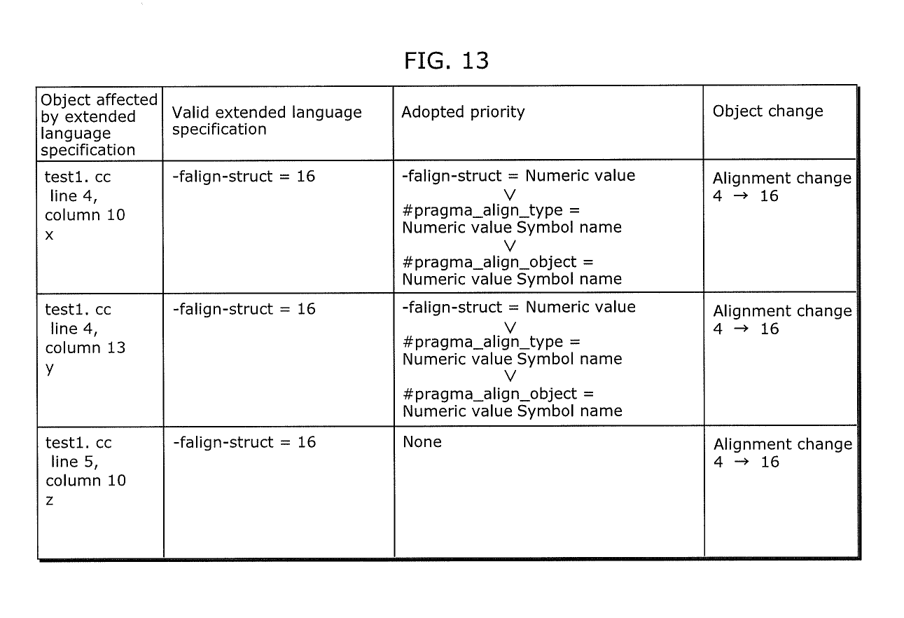

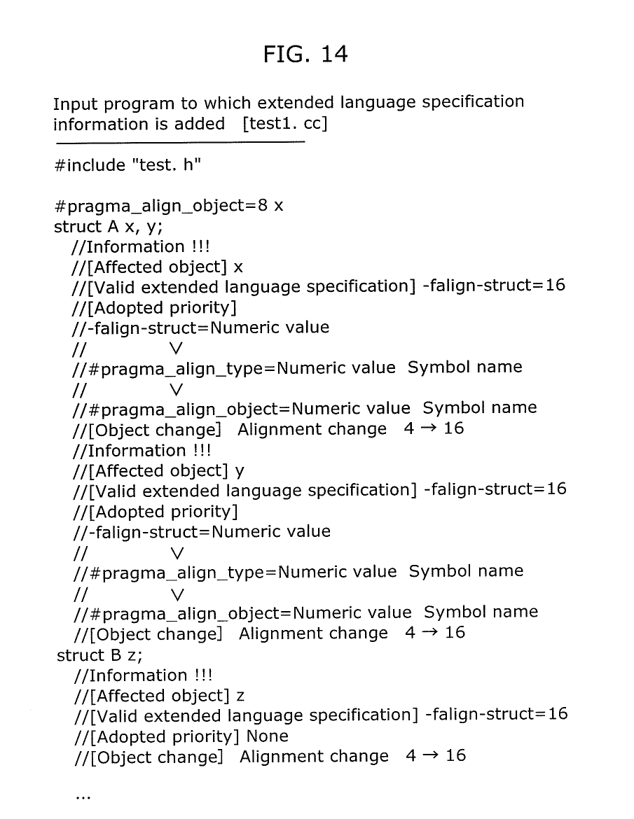

FIG. 13 is a table showing an analysis result registered in the extended language specification information database 51, for the input program in Example 2 of the present invention. FIG. 14 is a diagram showing the input program to which the extended language specification information is added in Example 2 of the present invention. In Example 2, the result of registering the extended language specification information upon completion of the extended language specification analysis step (S1) is shown in the table in FIG. 13, and the result of executing the extended language specification information-added input program output step (S32) is shown in FIG. 14.

In Example 2, as can be seen from FIG. 14, in the case where the user designates the priority of the extended language specification statements, too, the user can easily ascertain how each object in the input program is affected, while such ascertainment has not been possible in the conventional art. As a result, the number of inspection steps can be reduced.

### Example 3

The following describes Example 3. Example 3 is a specific example of adding the extended language specification information to the object program. The preconditions other than that the extended language specification information is added to the object program are the same as in Example 1.

In this case, the processing of the extended language specification analysis step (S1) and the processing of the extended language specification information-added input program output step (S32) which is a substep of the extended language specification information output step (S3) are the same as those in Example 1, and so their description is omitted.

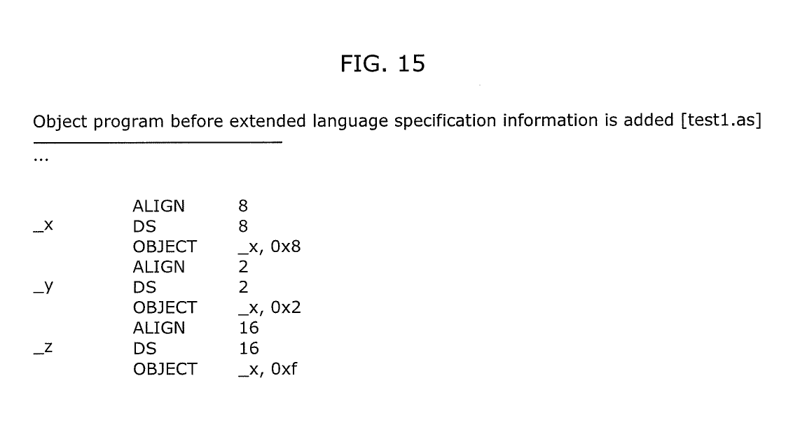

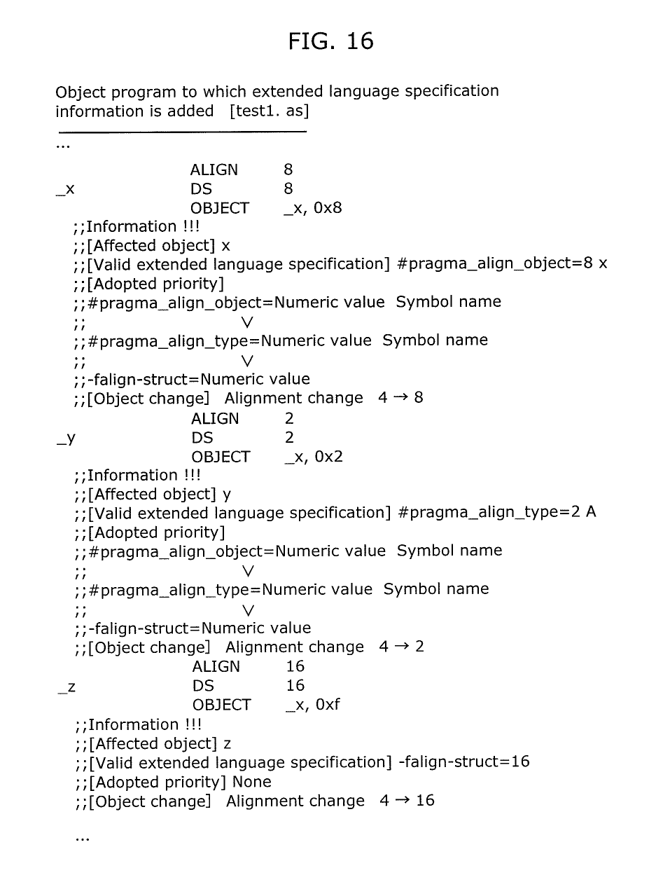

FIG. 15 is a diagram showing the object program before the extended language specification information is added in Example 3 of the present invention. FIG. 16 is a diagram showing the object program to which the extended language specification information is added in Example 3 of the present invention.

Since the extended language specification information is added to the object program in Example 3, the determination of step S33 in the extended language specification information output step (S3) results in yes, and the compiler executes the extended language specification information-added object program output step (S34).

In detail, in step S34, the compiler first generates the object program, and records the definition location of each object (S341). FIG. 15 shows an example of the object program generated in step S341, that is, an example of the object program before the extended language specification information is added, where the definition location of each object can be recognized. It is assumed that each object is defined by an OBJECT pseudo instruction in FIG. 15.

Next, the compiler executes the loop C in step S34, thereby inserting, for each of objects x, y, and z, the extended language specification information including the affected object, the valid extended language specification statement, the adopted priority, and the objet change at the definition location in the object program as comments (S343). The compiler then outputs the object program to which the extended language specification information is added as comments, as shown in FIG. 16 (S344).

In Example 3, as can be seen from FIG. 16, the user can easily ascertain how the object program is affected by the user designating the extended language specification statements, while such ascertainment has not been possible in the conventional art. As a result, the number of inspection steps can be reduced.

### Example 4

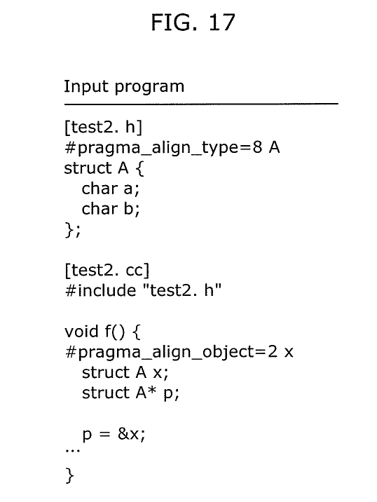

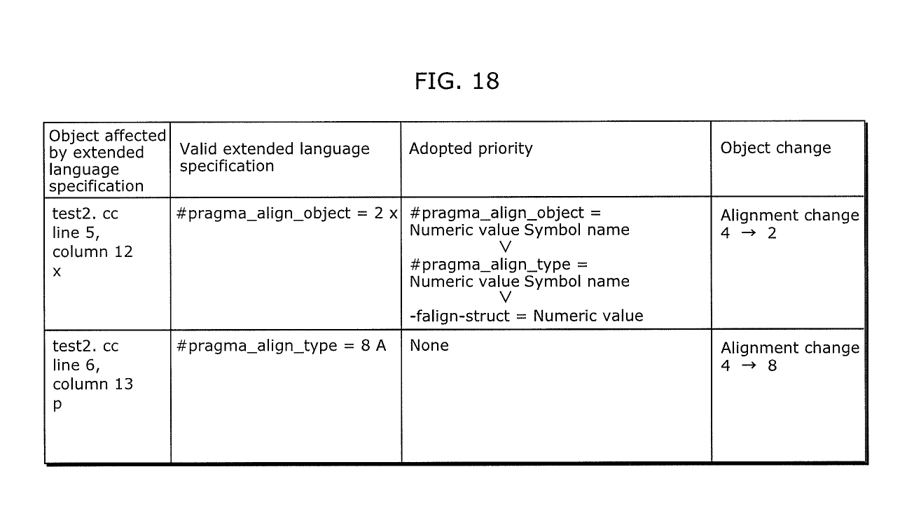

FIG. 17 is a diagram showing an input program in Example 4 of the present invention. FIG. 18 is a diagram showing extended language specification information registered in the extended language specification information database 51, for the input program in Example 4 of the present invention. In FIG. 17, the input program is made up of test2.h and test2.cc.

In Example 4, as preconditions, the user designates (by an option or the like) that extended language specification information is not to be outputted, and inter-object misalignment is to be warned. The user also designates (by an option or the like) that an extended language specification designation suggestion is not to be presented. Moreover, there is no designation of priority of extended language specification statements by the user.

Upon starting compilation, the compiler first executes the extended language specification analysis step (S1). Since the processing of the extended language specification analysis step (S1) is substantially the same as that in Example 1, its description is omitted. FIG. 18 shows extended language specification information registered in the extended language specification information database 51, upon completion of the extended language specification analysis step (S1). As shown in FIG. 18, alignment of object x is changed to 2 by an extended language specification statement, and alignment of object p is changed to 8 by an extended language specification statement.

Next, the compiler performs the determination of step S2. According to the above preconditions, the determination of step S2 results in no, and the compiler performs the determination of next step S4.

According to the above preconditions, the determination of step S4 results in yes, and the compiler executes the inter-object warning output step (S5). In the inter-object warning output step (S5), the compiler executes the loop D, where the determination of step S52 is performed on an expression or statement referencing each of objects x and p. In Example 4, the determination is performed on an assignment statement “p=&x” in the input program shown in FIG. 17. As shown in FIG. 18, the alignment of object x is 2, and the alignment of object p is 8. In Example 4, however, alignment expected in the statement is 8 which is alignment of the type resulting from the assignment statement. Since the alignment of object x is different from the expected alignment 8, the compiler determines object x as misaligned, and executes step S53.

In step S53, a warning message to which the extended language specification information including the valid extended language specification statement of the misaligned object, the affected object, and the object change is added is displayed at the location of the above assignment statement.

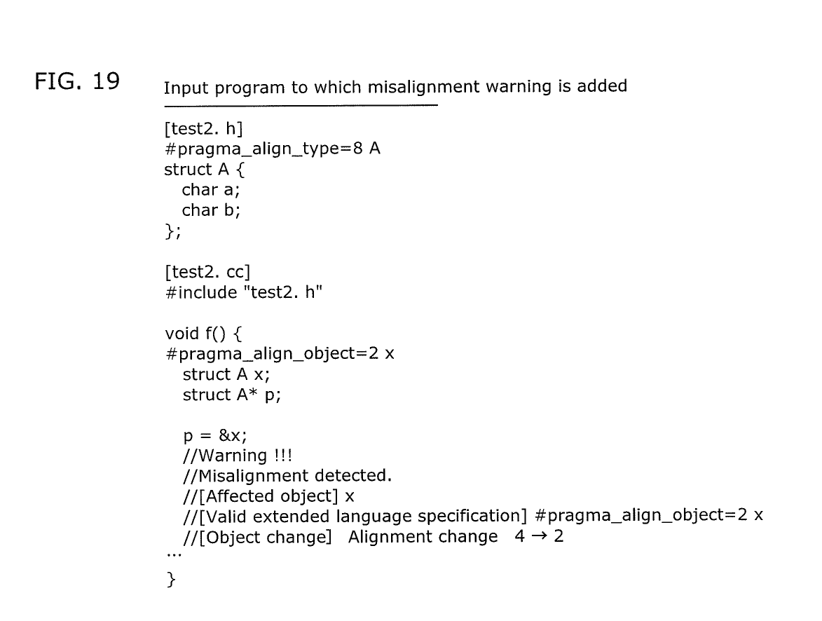

FIG. 19 is a diagram showing the input program to which the misalignment warning is added in Example 4 of the present invention. As can be seen from the warning display in FIG. 19, the unexpected misalignment that may occur by designating the extended language specification statements can be detected in compilation, while such detection has not been possible in the conventional art. As a result, the number of inspection steps can be reduced.

### Example 5

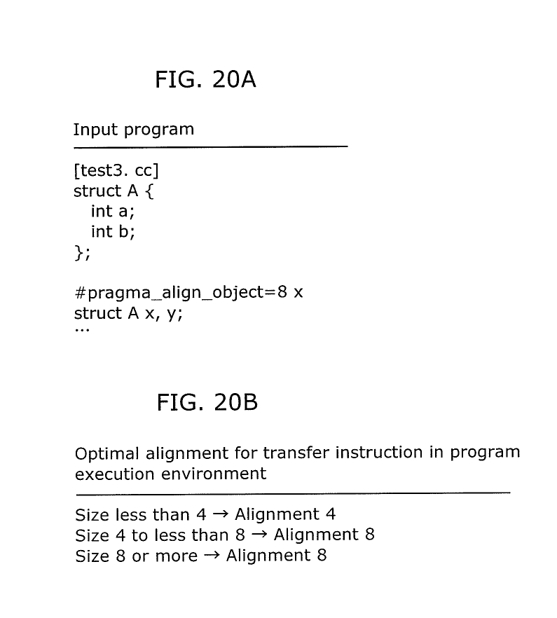

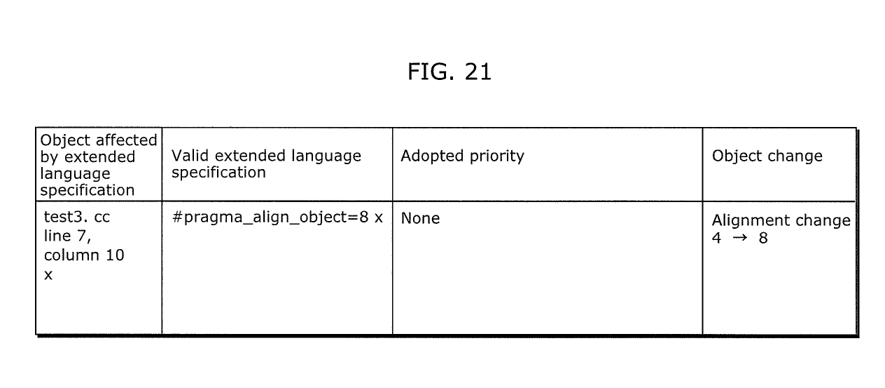

FIGS. 20A and 20B are diagrams showing an input program and compiling preconditions in Example 5 of the present invention. FIG. 21 is a diagram showing extended language specification information registered in the extended language specification information database 51, for the input program in Example 5 of the present invention. FIG. 20A shows the input program made up of test3.cc, and FIG. 20B shows optimal alignment for a transfer instruction in a program execution environment as a precondition in Example 5.

In Example 5, the optimal alignment for the transfer instruction in the program execution environment is registered in the compiler beforehand as a precondition. However, the present invention is not limited to this, and the alignment may be designated by the user upon compilation. As other preconditions, the user designates that extended language specification information is not to be outputted, inter-object misalignment is not to be warned, and an extended language specification designation suggestion is to be presented. Moreover, there is no designation of priority of extended language specification statements by the user.

Upon starting compilation, the compiler first executes the extended language specification analysis step (S1). Since the processing of the extended language specification analysis step (S1) is substantially the same as that in Example 1, its description is omitted. FIG. 21 shows extended language specification information registered in the extended language specification information database 51, upon completion of the extended language specification analysis step (S1). As shown in FIG. 21, alignment of object x is changed to 8 by an extended language specification statement.

Next, the compiler performs the determination of step S2. According to the above preconditions, the determination of step S2 and the determination of step S4 both result in no, and the determination of step S6 results in yes. The compiler then executes the optimization suggestion output step (S7).

In the optimization suggestion output step (S7), the compiler executes the loop E on each object. First, in step S72, the compiler obtains the optimal alignment for the transfer instruction in the program execution environment for the object. In Example 5, there are objects x and y, which each have type A (default size 8 and alignment 4). As shown in FIGS. 20A and 20B, the optimal alignment for the transfer instruction in the program execution environment is registered in the compiler beforehand as the precondition, indicating that the optimal alignment is 8 when the size is 8.

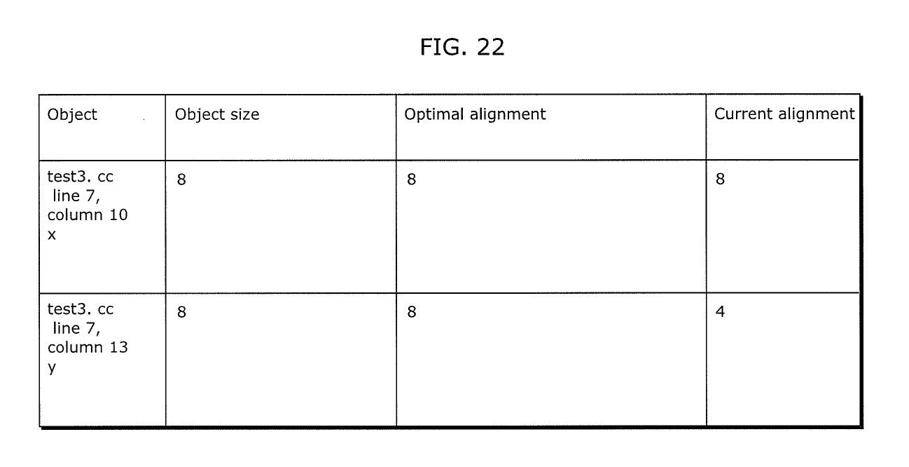

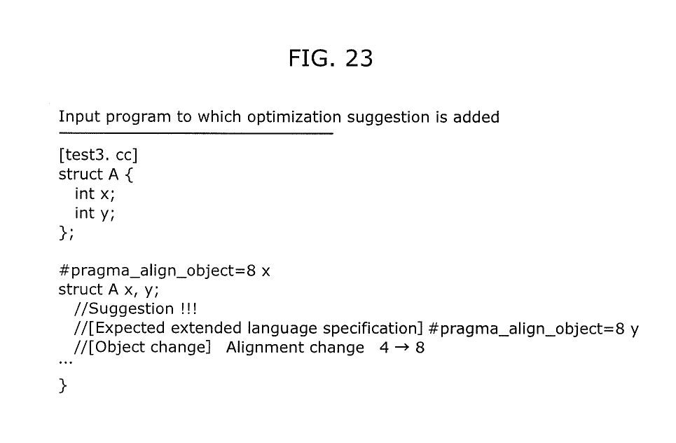

FIG. 22 is a table showing each object in the input program and its object size, optimal alignment, and current alignment in Example 5 of the present invention. FIG. 23 is a diagram showing the input program to which the optimization suggestion is added in Example 5 of the present invention.

As can be seen from FIG. 22, the optimal alignment is designated for object x by extended language specification designation by the user, but the optimal alignment is not designated for object y (whose alignment is 4 by default). Therefore, the determination of step S73 for object y results in no, and the compiler outputs a suggestion message to which an expected extended language specification statement and an expected object change are added, to display it to the user.

FIG. 23 shows the input program to which the suggestion message is added as comments. As can be seen from FIG. 23, an extended language specification statement for alignment designation that enhances code generation efficiency is suggested by the compiler, while such suggestion has not been possible in the conventional art. As a result, the number of program tuning steps by the user can be reduced.

Thus, the compiling method according to the present invention is implemented.

Though the suggestion message is displayed by adding comments to the input program in Example 5, the present invention is not limited to this method. For example, the suggestion message may be added to the input program and displayed on a monitor, or the suggestion message may be outputted as a text file. In other words, any method may be used so long as the user can ascertain the expected extended language specification statement, object change, and alignment.

Note that the compiler described above may be a compiling apparatus that includes processing units corresponding to the characteristic steps included in the compiling method according to the present invention. Such a compiling apparatus is briefly described below.

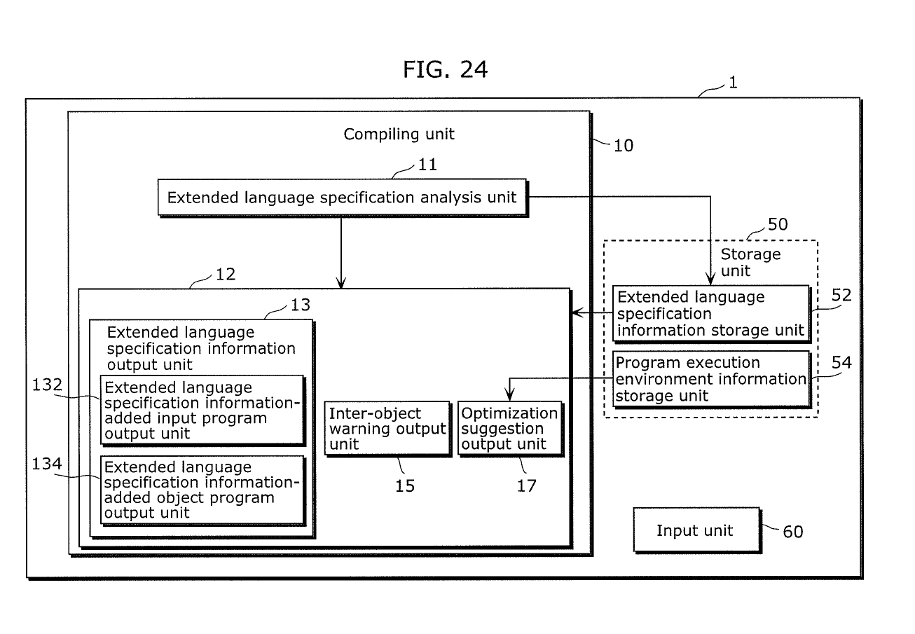

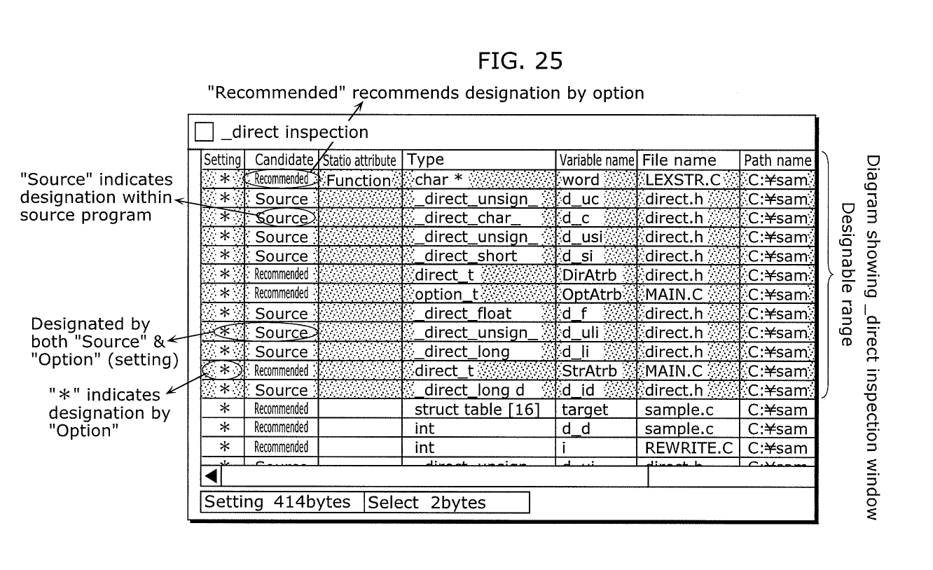

FIG. 24 is a diagram showing a structure of the compiling apparatus that includes the processing units corresponding to the characteristic steps included in the compiling method according to the present invention.

In FIG. 24, a compiling apparatus 1 includes a compiling unit 10, a storage unit 50, and an input unit 60.

The compiling unit 10 includes: an extended language specification analysis unit 11 that analyzes extended language specification information, i.e., information about which part of an input program is affected by a plurality of extended language specification statements added in the input program by the user, based on priority of the plurality of extended language specification statements; and an output unit 12 that outputs the extended language specification information analyzed by the extended language specification analysis unit 11 or information based on the extended language specification information.

The output unit 12 includes an extended language specification information output unit 13 that outputs the extended language specification information analyzed by the extended language specification analysis unit 11 as a compiling result, to display it to the user. The output unit 12 also includes: an inter-object warning output unit 15 that detects inter-object misalignment based on the extended language specification information analyzed by the extended language specification analysis unit 11, and outputs a warning indicating that misalignment occurs as a result of compilation; and an optimization suggestion output unit 17 that outputs, based on the analyzed extended language specification information, a suggestion for an extended language specification designation method that enhances code performance, to the user.

The extended language specification information output unit 13 includes: an extended language specification information-added input program output unit 132 that outputs the input program to which the extended language specification information is added; and an extended language specification information-added object program output unit 134 that outputs the object program to which the extended language specification information is added.

The storage unit 50 includes an extended language specification information storage unit 52 and a program execution environment information storage unit 54.

The input unit 60 receives designation from the user, and adds an extended language specification statement in the program.

In the compiling apparatus 1, the extended language specification information output unit 13, the inter-object warning output unit 15, and the optimization suggestion output unit 17 can each operate independently after the analysis by the extended language specification analysis unit 11. For each of the extended language specification information output unit 13, the inter-object warning output unit 15, and the optimization suggestion output unit 17, whether or not to perform the operation can be selected according to the user's designation (such as an option).

Note that the extended language specification information storage unit 52 may be omitted from the compiling apparatus 1, so long as the compiling apparatus 1 can record and reference the analysis result of the extended language specification analysis unit 11. In such a case, the extended language specification information database 51 or the like may separately be provided. Here, the compiling apparatus 1 stores the analysis result of the extended language specification analysis unit 11 in the extended language specification information database 51, and references the extended language specification information which is the analysis result stored in the extended language specification information database 51. Likewise, the program execution environment information storage unit 54 may be omitted from the compiling apparatus 1, so long as the optimization suggestion output unit 17 can reference the program execution environment information.

As described above, according to the present invention, a compiling method and a compiling program that enable the user to easily ascertain how an input program and an object program are affected by designation of a plurality of extended language specifications (extended language specification statements) can be realized. As a result, the number of inspection steps can be reduced. Moreover, unexpected misalignment that may occur by the user designating the extended language specifications (extended language specification statements) in the input program can be accurately detected in compilation, in consideration of priority of the extended language specifications (extended language specification statements). Furthermore, an extended language specification (extended language specification statement) for alignment designation that enhances code generation efficiency can be suggested by the compiler. As a result, not only the number of inspection steps can be reduced, but also the number of program tuning steps by the user can be reduced.

The present invention may be realized not only as an apparatus, but also as an integrated circuit that includes the processing units included in the apparatus. In addition, the present invention may be realized not only as a compiling method, but also as a program that causes a computer to execute the steps included in the compiling method.

Although only some exemplary embodiments of this invention have been described in detail above, those skilled in the art will readily appreciate that many modifications are possible in the exemplary embodiments without materially departing from the novel teachings and advantages of this invention. Accordingly, all such modifications are intended to be included within the scope of this invention.

### INDUSTRIAL APPLICABILITY

The present invention is applicable to a compiling method and a compiling program. In particular, the present invention is applicable to a compiling method and a compiling program that provide extended language specifications to achieve optimal performance in a program execution environment.

What is claimed is:

1. A compiling method for translating an input program to an object program, said compiling method comprising:
analyzing, in the case where a plurality of extended language specifications are designated in the input program, the designated plurality of extended language specifications, to determine which part of the input program is affected by the designated plurality of extended language specifications; and
outputting information about the part, together with the object program.

2. The compiling method according to claim 1,
wherein said analyzing includes
determining, based on priority specified for the plurality of extended language specifications, designation of a valid extended language specification from among the plurality of extended language specifications, and determining the part of the input program affected by the designation of the valid extended language specification, and
said outputting includes
outputting the information about the part, together with the object program, the information about the part indicating at least one of: the designation of the valid extended language specification; an object in the input program affected by the designation of the valid extended language specification; the specified priority; and a change of the object as a result of being affected by the designation of the valid extended language specification.

3. The compiling method according to claim 2,
wherein said outputting includes
including the information about the part in the input program, and outputting the input program including the information about the part, together with the object program.

4. The compiling method according to claim 2,
wherein said outputting includes
including the information about the part in the object program, and outputting the object program including the information about the part.

5. The compiling method according to claim 2,
wherein said outputting includes
including the information about the part in the object program, and outputting the object program including the information about the part, the information about the part indicating at least one of: the designation of the valid extended language specification; an object in the input program affected by the designation of the valid extended language specification; the specified priority; a change of the object as a result of being affected by the designation of the valid extended language specification; an assembler instruction in a compiling process affected by the designation of the extended language specification; and an assembler instruction in a compiling process in the case where the designation of the extended language specification is nullified.

6. The compiling method according to claim 1,
wherein said outputting further includes
checking, based on the information about the part, whether or not alignment of an object in the input program is changed and, in the case where the changed alignment of the object does not match expected alignment, outputting a warning indicating that the object is misaligned.

7. The compiling method according to claim 1,
wherein said outputting further includes:
checking, for each object in the input program including an object affected by the designation of the plurality of extended language specifications, whether or not alignment of the object is changed to optimal alignment for a transfer instruction in a program execution environment, based on the information about the part; and in the case where alignment of at least one object in the input program is not changed to the optimal alignment, outputting a suggestion for the optimal alignment of the at least one object.

8. The compiling method according to claim 2,
wherein the priority of the plurality of extended language specifications is pre-specified.

9. The compiling method according to claim 8,
wherein the priority of the plurality of extended language specifications is further specified by a user, and
said analyzing uses the priority specified by the user, as the priority specified for the plurality of extended language specifications.

10. A non-transitory computer-readable recording medium for use in a computer, said recording medium having a computer program for translating an input program to an object program recorded thereon for causing the computer to execute:
analyzing, in the case where a plurality of extended language specifications are designated in the input program, the designated plurality of extended language specifications, to determine which part of the input program is affected by the designated plurality of extended language specifications; and
outputting information about the part, together with the object program.

11. A compiling apparatus that translates an input program to an object program, said compiling apparatus comprising:
an analysis unit configured to analyze, in the case where a plurality of extended language specifications are designated in the input program, the designated plurality of extended language specifications, to determine which part of the input program is affected by the designated plurality of extended language specifications; and
an output unit configured to output information about the part, together with the object program.
